(19) United States
(12) Patent Application Publication
(10) Pub. No.: US 2005/0261931 A1
(43) Pub. Date: Nov. 24, 2005

(54) System and method of fund raising utilizing prepaid gift certificates/gift cards

(76) Inventor: Thomas A. O'Hara, Longmeadow, MA (US)

Correspondence Address: MCCORMICK, PAULDING & HUBER LLP, CITY PLACE II, 185 ASYLUM STREET, HARTFORD, CT, 06103, US

(21) Appl. No.: 11/130,707

(22) Filed: May 17, 2005

Related U.S. Application Data
(60) Provisional application No. 60/572,185, filed on May 18, 2004.

(51) Int. Cl. G06F 17/60

(52) U.S. Cl. 705/1

(57) ABSTRACT

The present invention is a system and method of fundraising utilizing prepaid gift certificates or gift cards. The system includes a program coordinator, a distributor, a fundraiser, and at least one vendor that generates prepaid certificates or cards. The program coordinator prepares a marketing program including brochure and order form. The program coordinator, or a distributor of the coordinator, places the program with fundraisers. The fundraiser sells vendors' gift certificates or cards, and collects monies and consumer information. The fundraiser keeps their portion of the proceeds and returns the remaining proceeds and consumer information to the program coordinator, or the distributor for forwarding to the coordinator. The program coordinator enters all orders and consumer information. The program coordinator keeps their portion of the money and returns the remaining money and customer information to the vendor. The vendor sends a catalog, a gift certificate or card to the consumer.

### CROSS REFERENCE TO RELATED APPLICATIONS

The present application claims the benefit of Provisional Patent Application No. 60/572,185 filed on May 18, 2004.

### FIELD OF THE INVENTION

The present invention relates to a method and system of fundraising. In particular, the present invention relates to a system and method of product fundraising utilizing prepaid gift certificates and gift cards.

### BACKGROUND OF THE INVENTION

Schools and groups often raise funds by selling gifts. The gifts sold, however, are typically perishable items such as cakes, candy or cookies, or are fragile such as ceramics and glass. Moreover, gifts typically offered are of a relatively low quality and may be over-priced. Additionally, the consumer must purchase gifts from a catalog, shopper, brochure, or “tag” (collectively a “Shopper”) that is limited in scope. These gifts often have a low perceived value and many consumers find the gifts unappealing. Therefore, consumers may be reluctant to purchase such gifts even if they support the school or group attempting to raise funds. Likewise, school or group members may be reluctant to participate in fund raising campaigns, as they themselves believe the gifts to be of low value.

Moreover, the fundraising market is extremely lucrative, with sales of approximately four billion dollars per year. However, as mentioned above, many existing fundraising programs utilize industry vendors who supply imported gifts that are of a low perceived quality and value. Companies that offer high-quality gifts, particularly those that sell such gifts through mail-order catalogs, typically do not participate in the traditional Shopper direct-to-school fundraising market.

Additionally, many fundraising programs are relatively complicated. The Shoppers generally contain many items with multiple Stock Keeping Unit (“SKU”) numbers. Given the multitude of SKU numbers, the order forms or order takers may be difficult or burdensome to complete. Moreover, once orders are taken, the gifts are usually shipped to the school or group and then need to be distributed to the students or group members, often children, and then to the consumers 10. Numerous parent and school volunteers accomplish this process.

Furthermore, fundraising programs could be used to gather valuable marketing data regarding consumer-purchasing habits. Current programs cannot gather and compile such marketing information because the sellers, typically children, do not capture the requisite consumer information.

In light of the above, a need exists for a system and method of fundraising involving the sale of high quality gifts, that is simple and convenient for all parties involved and that offers schools a highly profitable method of fundraising. A need also exists for a system and method of fundraising that offers the consumer multiple purchasing options, that allows mail-order catalog companies, and like vendors, access to the lucrative fundraising market and offers catalog companies a way to acquire new customers at a lower cost than through traditional acquisition methods. The present invention fulfills these needs and more.

### SUMMARY OF THE INVENTION

It is an object of the present invention to provide a system and method of fundraising that offers consumers a wide variety of high-quality gifts.

It is an additional object of the present invention to provide a system and method of fundraising that offers consumers a convenient means for purchasing gifts such as through a mail-order catalog.

It is yet another object of the present invention to provide a system and method of fund raising that provides a simple and convenient and profitable means for a school or group to sell gifts from mail-order catalogs.

It is a further object of the present invention to provide a system and method of fund raising in which a school or group sells prepaid gift certificates or gift cards at a sustainable profit and volume compared to existing gift certificate or “scrips” programs offered to schools.

It is yet another object of the present invention to provide a system and method of fundraising that allows certain mail-order companies and like vendors to reach the fundraising market and capitalize on new sources of revenue and new sources of name acquisition at a lower cost than traditional methods.

It is yet another object of the present invention to provide a system and method of fundraising that gathers and compiles consumer-purchasing data.

An additional object of the present invention is to provide a system and method of delivery of fundraising products directly to the consumer's home thereby eliminating the need for the school, students, parents and school volunteers to be involved in the delivery of purchases.

An embodiment of the present invention is a method of fundraising utilizing prepaid gift cards that may be used to purchase goods or services from a vendor. The method includes the steps of: obtaining materials necessary to sell prepaid gift cards to consumers, selling prepaid gift cards to consumers, collecting payment and personal information from the consumers upon the sale of the prepaid gift cards, and submitting a portion of the payment and personal information to the vendor.

These and other objects and advantages of the present invention will become readily apparent upon further review of the following drawings and specification.

### BRIEF DESCRIPTION OF THE DRAWINGS

FIG. 1 is a schematic of a system for fundraising according to the present invention.

FIG. 2 is a flow chart illustrating steps of a method of fundraising of the present invention.

FIG. 3 is a flow chart illustrating steps of a method of gathering and disseminating purchaser data to vendors.

### DETAILED DESCRIPTION OF THE PREFERRED EMBODIMENT

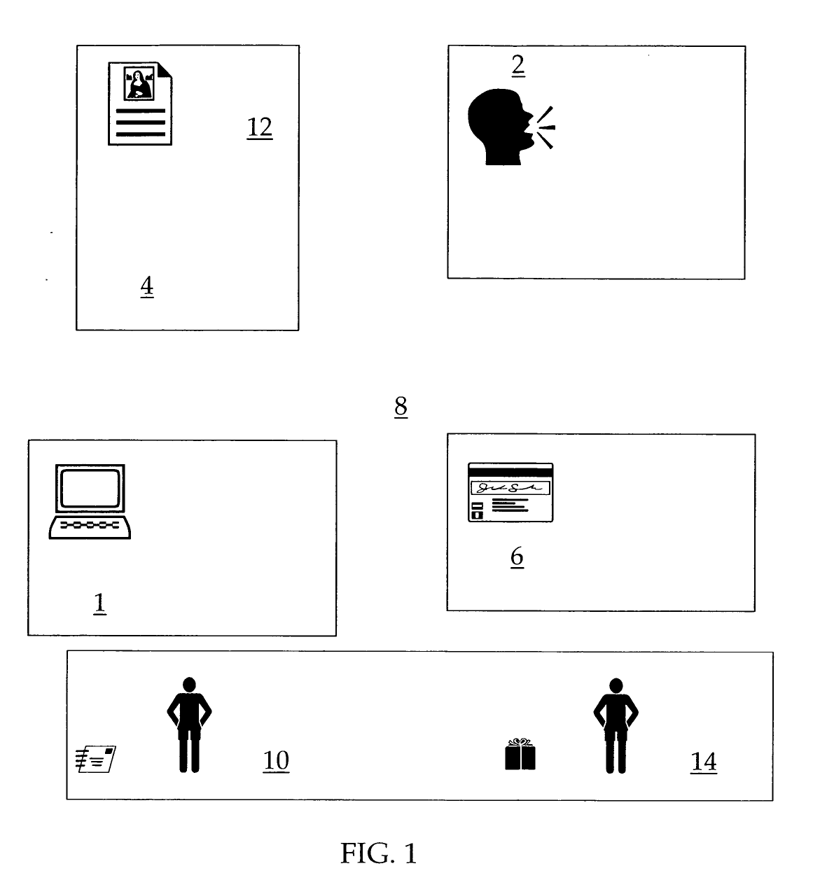

As shown schematically in FIG. 1, the present invention includes program coordinator 1, a distributor 2, a fundraiser 4, generally a school or group, and at least one vendor 6, preferably a mail-order company or vendor who generates prepaid gift certificates or gift cards 8. The vendor 6 generates the prepaid certificates or cards and sends them directly to consumers 10. The fundraiser 4 sells the prepaid certificates or cards to the consumers 10 and collects the consumers' pertinent information and payment. The fundraiser 4 then submits the payment amount collected, less the fundraiser's 4 portion, and information to the program coordinator 1. The program coordinator 1 then enters and stores all the information in a database and sends the payment, orders and relevant data to the individual vendors 6. The vendors 6 process the orders and either mails or electronically transmits their catalogs with the appropriate value of gift certificate or card directly to the consumer 10.

The program coordinator 1 is the entity that coordinates the fundraising system of the present invention. Typically, the program coordinator 1 will utilize a distributor 2, such as an independent sales person, to execute the fundraising system. The distributor 2 offers the fundraising system of the present invention to the fundraiser 4. The distributor 2 supplies the fundraiser 4 with selling materials such as brochures, which feature at least one vendor that preferably sells products through mail-order catalogs, over the Internet or at retail locations. As will be appreciated, however, the program coordinator 1 may offer the fundraising system directly to the fundraiser 4 and supply the fundraiser 4 with selling materials without the assistance of a distributor 2.

The program coordinator 1 preferably has pre-existing partnerships with multiple vendors 6. The distributor 2, or in some cases the program coordinator 1, may offer different selling materials featuring different vendors 6 depending on the type of fundraiser e.g., a school or a church group. Preferably, the selling materials feature multiple mail-order companies that sell high quality products and have brand name recognition among consumers 10. Examples of such vendors include Lego®, Northern Tool®, Delia's®, Zingermans ®, Luminescence® and Brookstone®.

It is an important aspect of the present invention that the vendors 6 offer and sell high-quality products. As mentioned above, many existing fundraising programs sell gifts that are of a low-perceived value and quality which consumers may be reluctant to purchase even though they support the school or group. Moreover, it is important that the vendors 6 offer and sell products through mail-order catalogs, over the Internet, or at retail locations. Typically, the distributors deliver the products to the school or group who must then distribute the products to the consumers. The present system is convenient for the school or group as it is not responsible for delivering gifts and the consumer who may buy gifts through various high quality venues.

In the present invention, vendors 6 ship the products directly to the consumer 10, or the redeemer 14 should the consumer 10 have purchased the card for someone else, after the products are ordered through the catalog or like venue and are paid for, or partially paid for, via the prepaid gift certificate or gift card. Therefore, as mentioned above, the school or group does not have to distribute the gifts and the consumer has multiple choices as to where he or she purchases the gifts. For example, the consumer can use the prepaid certificate or gift card to order a gift from a mail-order company's catalog or in person at a mail-order company's retail location. Thus, the system is convenient for both the fundraising school or group and the consumer. Additionally, many consumers order goods through mail-order catalogs so the present system captures money that consumers would spend outside of the fundraising system of the present invention.

Returning now to FIG. 1, the distributor 2 receives the payment, less the fundraiser's portion of the proceeds, and the consumer information. The distributor 2 forwards information and payment to program coordinator 1 who enters and stores the information as a database. The program coordinator 1 then subtracts its portion of the proceeds from the payment and sends the remaining funds along with orders and marketing data to the individual vendors. The program coordinator 1 may then provide a commission to the distributor 2 for the sale of the system to the fundraiser 4. As will be appreciated, the program coordinator 1 may receive the proceeds directly from the fundraiser 4.

The vendors then ship the prepaid gift certificates or gift cards to the consumers 10 along with the vendors' catalogs and other materials notifying the consumer 10, or redeemer 14 should the consumer order a card for someone else, as to where they may use the prepaid gift certificates or gift cards. Alternatively, the program coordinator 1 may ship the activated gift certificates or gift cards to the consumer 10 or redeemer 14.

It is an additional important aspect of the present invention that the program coordinator stores the consumer information as a database. The consumer information is valuable in that it contains data regarding how much money consumers 10 are spending, where they are spending money and in what geographic location. Many existing fundraising systems do not and cannot gather and/or disseminate consumer spending data.

As will be appreciated, various Data Base Management Systems (“DBMS”) for entering and storing the data may be utilized. Preferably, an enterprise DBMS with a high level of scalability is employed such as Oracle®, IBM DB2® or Microsoft SQL Server®. The DBMS is located on the program coordinator's computer system which may or may not be connected to a network. The database can be used to generate reports regarding sales that may be distributed to the various vendors on a periodic basis and may be used by the vendors for future catalog mailings. The data may also be sold to other entities for marketing purposes.

Returning again to FIG. 1, as will be appreciated, the fundraiser is typically a charitable organization which often is an organization that is awarded nonprofit status by the Internal Revenue Service (“IRS”), or other tax processing governmental body. Charitable organizations include nonprofit tax exempt organizations that are classified under Section 501(c) (3) of the IRS Code. These organizations include schools, sports teams, cheerleading and dance groups, churches, educational organizations, hospitals and medical research organizations and publicly supported organizations such as museums and libraries. Additionally, as will be appreciated, gift certificates and gift cards are not subject to state or local sales tax.

Preferably, the fundraiser 4 receives the selling materials 12 from the distributor 2. Typically, the distributor 2 will mail/deliver the selling materials to the fundraiser 4. The fundraiser 4 then, utilizing the selling materials, sells the prepaid gift certificates or gift cards to consumers 10. To accomplish this, the fundraiser 4 will contact potential consumers 10 much like conventional fundraising programs. With the example of a school, students or their parents would sell the cards to their friends, parents, parents' friends, relatives, acquaintances and coworkers. As part of the selling process, fundraiser 4 gathers the consumers' information such as name, address, email, phone number, and name and/or SKU number of the vendor of the prepaid certificate or card purchased, along with the amount of the certificate or card and the payment.

When all fundraising is complete, the fundraiser 4 compiles the consumer information and payments, less the fundraiser's portion of the proceeds. The fundraiser 4 may then submit the consumer information electronically over a network or in paper form either to the distributor 2 or the program coordinator 1. Likewise, the fundraiser 4 may mail payment or electronically transfer funds to the distributor 2 or program coordinator 1.

This simplified ordering process is an additional important aspect of the present invention. As mentioned above, many existing fundraising programs involve relatively complicated order forms in which the sales person must record SKU numbers for hundreds of products in a single catalog often referred to as a shopper. In the present system, the sales person need only check off or otherwise record an SKU number for the vendor of the prepaid certificate or card and the amount of the certificate or card. Preferably, the fundraiser 4 offers consumers 10 a choice of gift certificates/gift cards. Thus, there are fewer SKU numbers for the salesperson to record on the order form and the process is thereby simplified. Conversely the redeemer 14 has a much wider choice of merchandise than offered in the shopper as the catalog vendor may offer thousands of items in their catalogs.

As mentioned above, the vendor mail-order companies are preferably those that offer high quality goods through catalog mail order sales. The vendors may also sell their products at retail locations and on the Internet. Preferably, the vendors generate the prepaid gift certificates or gift cards. When the vendors receive the consumer information and payment, they generate the prepaid certificate or card in the purchased amount. Preferably, the certificates or cards are available in various dollar increments. It is preferable, however, that the prepaid amounts be relatively high to ensure a high-dollar volume per order so that the fundraiser 4 has a high level of profit. Currently, the average price of a shopper SKU in fundraising is $10.00. Although the preferred embodiment utilizes vendor-specific prepaid certificates or cards, universal certificates or cards issued by the program coordinator that may be used to purchase goods from multiple mail-order vendors may also be employed.

It is an important aspect of the present invention that the vendors' prepaid certificates or cards are sold by fundraisers. Typically, mail-order vendors that sell products through catalogs have a low customer acquisition rate, approximately one percent of purchasers from mailed catalogs. With fundraisers selling the prepaid certificates or cards for use with the mail-order vendors' catalogs, a much higher conversion rate of thirty to fifty percent is possible. Additionally, the mail-order vendors benefit from an association with a fundraiser, i.e. a charitable organization, and benefit from national advertising in the selling materials utilized by the fundraisers to sell the prepaid certificates or cards. Moreover, the vendors acquire new customer names at a potential profit as compared to traditional prospecting means.

Returning now to FIG. 1, after receiving consumer information, the vendors activate the prepaid certificates or cards 6. This may be accomplished through the use of a Point of Sale (“POS”) terminal such as a Verifone Tranz® or like terminal. The vendors then mail or electronically transmit the prepaid certificates or cards to the consumer. The certificates or cards may be used as soon as they have been activated. Alternatively, the program coordinator 1 may activate the prepaid certificates or cards utilizing a POS terminal and then ship the activated certificates or cards directly to the consumers 10.

As mentioned above, the use of prepaid certificates or cards is an important aspect of the present invention. The certificates or cards are compact, sturdy and easily shipped unlike many gifts available through existing fundraising programs. Moreover, the prepaid certificate or card may be redeemed through mail-order catalog, retail store or over the Internet. The certificates or cards also benefit the vendors in that individuals may redeem their certificates or cards for items with a higher price than the initial value on the certificate or card and will thus spend more than the value of the certificate or card. Preferably, consumers may order a minimum of twenty-dollars with their gift cards and only one gift card may be redeemed per catalog order.

At times, the vendors 6 may receive a portion of the proceeds. For example, with a mail-order vendor receiving five percent, the vendor would receive one dollar of cash revenue for each twenty-dollar card sold. This system is desirable for mail-order vendors in that the program will generate high acquisition rates compared to conventional catalog mailings. Redeemers 14 will typically spend more than the initial prepaid certificate or card value, and the vendors 6 have access to customer information for future catalog mailings.

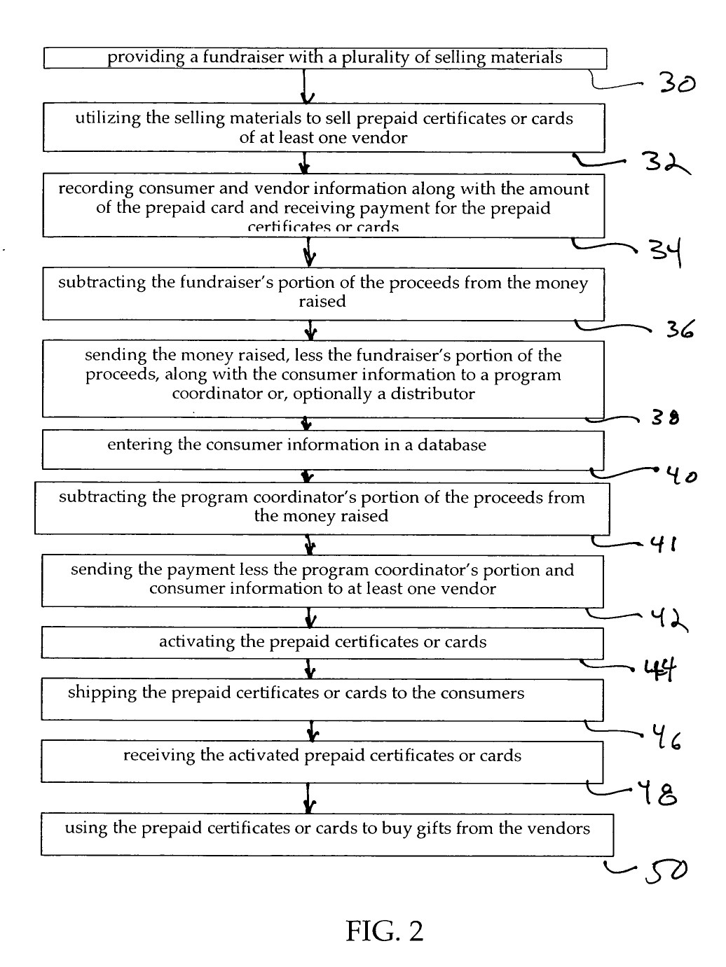

FIG. 2 is a flow chart indicating steps taken by a method of the present invention in conducting a fundraising program. Initially, the distributor provides a fundraiser 4 with a plurality of selling materials as noted at 30. As mentioned above, the selling materials and vendors may vary depending upon the identity of the fundraiser 4. Generally, the selling materials are brochures providing information on the various participating vendors. The fundraiser 4 then utilizes the selling materials to sell prepaid gift certificates or cards of the vendors, as recorded at 32. Alternatively, the program coordinator 1 may provide the fundraiser 4 with the selling materials.

Once a fundraiser 4 has made a sale, the fundraiser 4 submits the simplified order form containing the name, address, email and telephone number of the consumer and the SKU number and name of the vendor, along with the amount of the prepaid certificate or card and other information, as noted at 34. The fundraiser 4 receives payment from the sales person at this step as well.

As recorded at 36, when all fundraising is complete, the fundraiser 4 subtracts its portion of the proceeds from the money raised. As mentioned previously, the percentage can vary. The fundraiser 4 then provides the money raised, less its portion of the proceeds, along with the purchaser information to the distributor as shown at 38. The transfer of information and payment to the program coordinator may be through the mail or may be electronic over a network.

As noted at 40, the distributor then sends the information and payment to the program coordinator. The program coordinator then enters the information in its DBMS on its computer system. The program coordinator then subtracts its portion of the proceeds from the payment and sends the payment, if any, and consumer information to the various mail-order vendors, as recorded at 42. As mentioned above, the program coordinator may collect the information and funds directly from the fundraiser and forward both to the vendors without the assistance of a distributor.

As recorded at 44, the vendor receives the consumer information and payment, if any, and then activates the prepaid certificates or cards. As mentioned above, the vendor uses a POS terminal to activate the certificates or cards. Alternatively, the distributor may activate the certificates or cards at its own POS terminal.

The activated prepaid certificates or cards are then shipped or electronically transmitted to the consumers 10, as noted at 46. In addition to the certificates or cards, the vendors' catalogs and materials regarding where and how the vendors' goods may be purchased are sent or electronically transmitted to the consumer at this time. Preferably each vendor sends the cards, catalog and supporting materials to the consumers 10, however, these materials may be sent by the program coordinator in an alternative embodiment.

As noted at 48, the consumers 10 receive the activated certificates or cards and may use the certificates or cards to purchase gifts or they may distribute them to other redeemers. Preferably, the redeemers will use the certificates or cards to buy gifts from the vendors' catalogs. However, redeemers may use the cards at retail locations or to purchase goods over the Internet. The certificates or cards may be used as soon as they are activated.

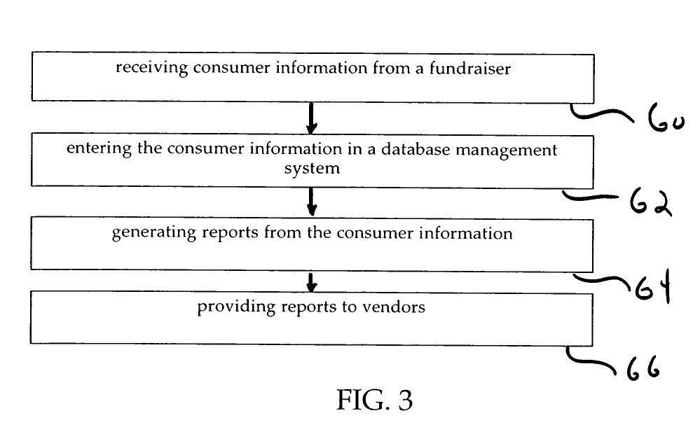

FIG. 3 is a flow chart illustrating the steps taken by a method of the present invention in compiling and providing consumer data to the vendors and other entities. Initially, the distributor receives the consumer information from the fundraiser, as noted at 60. The distributor provides the information to the program coordinator who then enters the information in its DBMS, as shown at 62. The database may have a data table containing multiple fields to identify the name, address, vendor certificate or card purchased and amount of purchase, among other information.

As noted at 64, the database can be used to generate reports which may be provided to the participating vendors on a periodic basis. The database can also be sold to other parties. The database is particularly valuable to the mail-order vendors in that they can send catalogs to consumers 10 that are highly likely to order from them.

Although the present invention has been described with reference to preferred embodiments, it will be appreciated by those of ordinary skill in the art, that various modifications to this invention may be made without departing from the spirit and scope of the invention.

1. A method of fund raising utilizing prepaid gift cards that may be used to purchase goods or services from a vendor comprising the steps of:
obtaining materials necessary to sell prepaid gift cards to consumers;
selling prepaid gift cards to consumers;
collecting payment and personal information from the consumers upon the sale of the prepaid gift cards; and
submitting a portion of the payment and said personal information to the vendor.

2. The method of fundraising of claim 1 wherein the materials necessary to sell prepaid gift cards are provided to a fundraiser by a coordinator.

3. The method of fundraising of claim 2 wherein the fundraiser sells the prepaid gift cards to consumers and collects payment and personal information from said consumers.

4. The method of fundraising of claim 3 wherein the personal information includes the name, address, phone number, email address, and vendor name or SKU number of the prepaid card that the consumer has purchased.

5. The method of fundraising of claim 3 wherein said payment and personal information collected by the fundraiser are provided by the fundraiser to the coordinator.

6. The method of fundraising of claim 5 wherein said program coordinator enters said personal information in a database management system.

7. The method of fundraising of claim 5 wherein the fundraiser subtracts and retains a portion of the payment and then submits the payment, less the fundraiser's portion, to the program coordinator who also subtracts and retains a portion of the payment before submitting the vendor's portion of the payment to the vendor.

8. The method of fundraising of claim 7, wherein the coordinator provides the consumers' personal information to the vendor thereby providing the vendor with a means for acquiring new customers.

9. The method of fundraising of claim 1, further comprising the step of:
sending the consumer the gift card.

10. A method of fundraising utilizing prepaid gift cards that may be used to purchase goods or services from a vendor comprising the steps of:
providing a fundraiser with materials necessary to sell prepaid gift cards to consumers;
selling prepaid gift cards to consumers, wherein the gift cards are sold to consumers by the fundraiser or its agent;
collecting payment and personal information from the consumers upon the sale of the prepaid gift cards, wherein the payment and personal information are collected by the fundraiser or its agent;
subtracting and retaining a portion of the payment, wherein the fundraiser subtracts and retains a portion of the payment;
submitting the payment, less the fundraiser's portion, and the personal information to a coordinator who in turn subtracts and retains a portion of the payment;
submitting the payment, less the fundraiser and coordinator's portions, as well as said personal information to the vendor; and
sending the consumer vendor-specific information regarding the goods or services offered by the vendor that may be purchased with the gift card, as well as the gift card, wherein the vendor sends the consumer the information and card upon receipt of the payment and personal information.

11. The method of fundraising of claim 10 wherein the fundraiser offers the consumer a choice between gift cards from more than one vendor.

12. The method of fundraising of claim 10 wherein the personal information includes the name, address, phone number, email address, and vendor name or SKU number of the prepaid card that the consumer has purchased.

13. The method of fundraising of claim 10 wherein said program coordinator enters said personal information in a database management system.

14. The method of fundraising of claim 12, wherein the coordinator provides the consumers' personal information as well as the payment, less the fundraiser and coordinator's portions, to the vendor thereby providing the vendor with a means for acquiring new customers.

15. A method of fundraising utilizing prepaid gift cards that may be used to purchase goods or services from a vendor comprising the steps of:
providing a fundraiser with materials necessary to sell prepaid gift cards to consumers;
offering a consumer for purchase a choice between more than one prepaid gift card to consumers;
selling prepaid gift cards to the consumer, wherein the gift cards are sold to the consumer by the fundraiser or its agent;
collecting payment and personal information from the consumer upon the sale of the prepaid gift cards, wherein the payment and personal information are collected by the fundraiser or its agent;
subtracting and retaining a portion of the payment, wherein the fundraiser subtracts and retains a portion of the payment;
submitting the payment, less the fundraiser's portion, and the personal information to a coordinator who in turn subtracts and retains a portion of the payment;
submitting the payment, less the fundraiser and coordinator's portions, as well as said personal information to the vendor; and
sending the consumer vendor-specific information regarding the goods or services offered by the vendor that may be purchased with the gift card, as well as the gift card, wherein the vendor sends the consumer the information and card upon receipt of the payment and personal information.

16. The method of fundraising of claim 15 wherein the personal information includes the name, address, phone number, email address, and vendor name or SKU number of the prepaid card that the consumer has purchased.

17. The method of fundraising of claim 15 wherein said program coordinator enters said personal information in a database management system.

18. The method of fundraising of claim 15, wherein the coordinator provides the consumers' personal information as well as the payment, less the fundraiser and coordinator's portions, to the vendor thereby providing the vendor with a means for acquiring new customers.

19. A system of fundraising utilizing prepaid gift cards that may be used to purchase goods or services from a vendor, said system comprising:
a fundraiser;
a coordinator;
at least one vendor; and
wherein said fundraiser offers consumers gift cards from at least one vendor for purchase, upon the sale of a gift card said fundraiser collects payment and personal information from said consumer and forwards a portion of said payment and personal information to the coordinator who then forwards a portion of the payment, along with the personal information, to the vendor, said vendor then ships the gift card to the consumer.

20. The system of fundraising of claim 19 further comprising:
a distributor, wherein said distributor supplies the fundraiser with materials used to sell the gift cards to consumers, said distributor also collects payment and personal information from the fundraiser and submits the payment and personal information to the coordinator.
